(19) United States
(12) Patent Application Publication
(10) Pub. No.: US 2018/0109924 A1
(43) Pub. Date: Apr. 19, 2018

(54) Cognitive Based Optimal Grouping of Users and Trip Planning Based on Learned User Skills

(71) Applicant: International Business Machines Corporation, Armonk, NY (US)

(72) Inventors: Priyanka Agrawal, Bangalore (IN); Pankaj Dayama, Bangalore (IN); Amrita Saha, Bangalore (IN); Srikanth G. Tamilselvam, Bangalore (IN)

(21) Appl. No.: 15/295,378

(22) Filed: Oct. 17, 2016

(51) Int. Cl. H04W 4/02; G01C 21/34; G06Q 10/06

(52) U.S. Cl. CPC H04W 4/028; G06Q 10/063112; G01C 21/3453

(57) ABSTRACT

Methods, systems, and computer program products for cognitive based optimal grouping of users and trip planning are provided herein. A computer-implemented method includes generating, for each of multiple users, a temporally-related driving skill model pertaining to each of multiple topographies, wherein the model is based on items of driving-related data associated with the users and topography-related information of trips driven by the users; selecting users to participate in a ride-sharing trip in a given vehicle based on the models and details of the ride-sharing trip; determining a route for the trip based on the models of the selected users and environmental factors; creating a schedule for the trip by assigning the selected users to drive during distinct portions of the route based on the models of the selected users and characteristics of the determined route; and outputting the schedule to at least the selected users.

### FIELD

The present application generally relates to information technology, and, more particularly, to transportation efficiency technology.

### BACKGROUND

Carpooling (also referred to, for example, as car-sharing or ride-sharing) refers to the sharing of vehicle journeys such that more than one person travels in a vehicle towards one or more destinations. By having multiple people using one vehicle, carpooling can reduce each person's travel costs, such as fuel cost, tolls, etc., as well as potentially reduce stress related to driving. Existing carpooling technology, however, commonly fails to account for and/or encompass participant variables such as, for example, driver skill with respect to various topographies.

### SUMMARY

In one embodiment of the present invention, techniques for cognitive based optimal grouping of users and trip planning based on learned user skills are provided. An exemplary computer-implemented method can include generating, for each of multiple users, a temporally-related driving skill model pertaining to each of multiple topographies, wherein the temporally-related driving skill model is based on (i) one or more items of driving-related data associated with the users and (ii) topography-related information of trips driven by the users. Such a method can also include selecting two or more of the users to participate in a ride-sharing trip in a given vehicle based on (i) analysis of the generated driving skill models and (ii) one or more details of the ride-sharing trip, as well as determining a route for the ride-sharing trip based on (i) characteristics of the selected users, derived from the generated driving skill models of the selected users, and (ii) one or more environmental factors. Further, such a method can include creating a schedule for the ride-sharing trip by assigning the selected users to drive the given vehicle during distinct portions of the route, wherein assigning is based on (i) the generated driving skill models of the selected users and (ii) one or more characteristics of the determined route, as well as outputting the schedule to at least the selected users.

In another embodiment of the invention, an exemplary computer-implemented method can include generating, for each of multiple users, a model that classifies a user's driving skill with respect to (i) each of multiple topographies and (ii) multiple durations of elapsed driving time, wherein generating comprises analyzing (a) one or more items of driving-related data associated with the users and (b) topography-related information of trips driven by the users. Such a method can also include selecting two or more of the users to participate in a ride-sharing trip in a given vehicle based on (i) analysis of the generated models and (ii) one or more details of the ride-sharing trip. Further, such a method can additionally include determining a route for the ride-sharing trip based on (i) characteristics of the selected users, derived from the generated models of the selected users, and (ii) one or more environmental factors, and segmenting the ride-sharing trip in multiple segments based on (i) elapsed travel time, (ii) topography-related information of the ride-sharing trip, and (iii) one or more of the environmental factors. Also, such a method can include creating a schedule for the ride-sharing trip by assigning one of the selected users to drive the given vehicle during each of the multiple segments, wherein assigning is based on (i) the generated models of the selected users and (ii) one or more characteristics of the determined route, and outputting the schedule to at least the selected users.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a diagram illustrating segmentation of drivers, according to an exemplary embodiment of the invention;

FIG. 3 is a diagram illustrating temporal driving skill model generation, according to an exemplary embodiment of the invention;

FIG. 4 is a diagram illustrating joint recommendations of route and grouping of participants, according to an exemplary embodiment of the invention;

FIG. 5 is a flow diagram illustrating techniques according to an embodiment of the invention;

FIG. 6 is a system diagram of an exemplary computer system on which at least one embodiment of the invention can be implemented;

FIG. 7 depicts a cloud computing environment according to an embodiment of the present invention; and

FIG. 8 depicts abstraction model layers according to an embodiment of the present invention.

### DETAILED DESCRIPTION

As described herein, an embodiment of the present invention includes cognitive based optimal grouping of users and trip planning based on learned user skills. At least one embodiment of the invention includes grouping users into one or more carpooling groups based on the driving abilities of the users with respect to different topographies. Such an embodiment can include analyzing temporal driving skills of a set of multiple users based on historical trip data and co-passenger ratings attributed to each of the users. Such analysis can be utilized for suggesting a trip route based on one or more environmental conditions (such as weather forecasts (rainfall), road visibility, road condition, etc.). Moreover, such an embodiment can include analyzing how driving skills of different users change with respect to changes in time, topography and environmental conditions.

Additionally, at least one embodiment of the invention includes scheduling a carpooling trip route based on the temporal driving skills of multiple participating users, as well as assigning each participating user/driver to drive the vehicle for a specific area of the route by segmenting the route into multiple areas. A route can be segmented, for example, based on topography as well as time. For instance, a new segment of the route can start every x hours (or every y miles), or whenever there is change in topography.

Accordingly, as further detailed herein, one or more embodiments of the invention include planning a carpool trip and dynamic updating such a carpool trip by jointly recommending particular users to be grouped and a particular trip route. Such a recommendation can be based on user driving data with respect to multiple different topographies.

Additionally, one or more embodiments of the invention can include generating a temporal driving skill model with respect to various topographies and environmental factors. As further detailed herein, such a model can be based, for example, on historical trip data, co-passenger ratings of drivers, etc. Using such a model, at least one embodiment of the invention can include generating a joint recommendation of a route for a given trip as well as a particular grouping of users for the given trip.

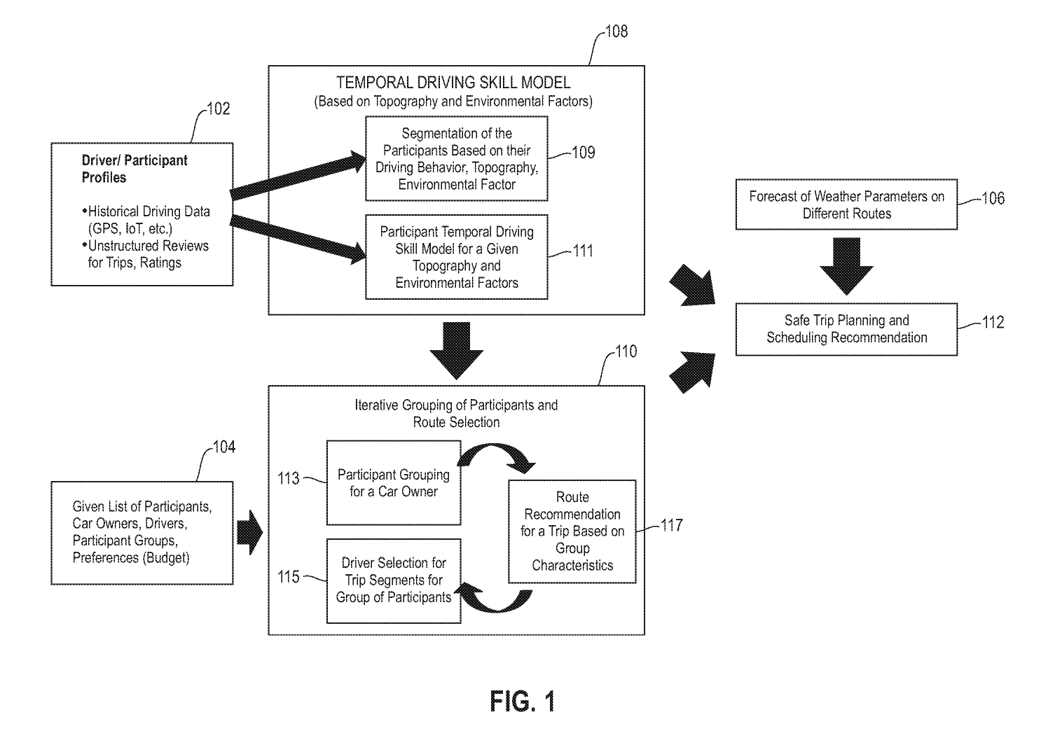

FIG. 1 is a diagram illustrating system architecture, according to an embodiment of the invention. By way of illustration, FIG. 1 depicts inputs that include driver/participant profiles 102, related carpooling data 104, and forecasts 106 of one or more weather parameters with respect to different routes and/or geographic areas. The driver/participant profiles 102 can include, for example, historical driving data for individuals (such as global positioning system (GPS) data and Internet of things (IoT) data from mobile phones, instrumented vehicles, etc.), route characteristics, and unstructured review information (such as passenger ratings). Such passenger ratings can be derived, for example, from online reviews for trips, wherein passengers share their experience as well as provide overall ratings for the trip. The carpooling data 104 can include, for example, identification of participants, car owners, drivers, participant groups, user preferences (such as budgetary preferences), etc. Individuals can, for example, register themselves on carpooling websites if they are interested in ride-sharing.

FIG. 1 also depicts a temporal driving skill model generator 108. The model generator 108, based on inputs comprising the driver/participant profiles 102, utilizes a participant segmentation component 109 (which segments participants based on driving behavior, topography, and/or environmental factors) to create a participant temporal driving skill model 111 for a given topography and a given set of one or more environmental factors.

Additionally, as depicted in FIG. 1, the generated model 111 is provided, along with the carpooling data 104, to an iterative grouping component 110, which generates a participant grouping for a car owner 113, a route recommendation for a trip 117 based on one or more group characteristics, and a driver selection for trip segments for a group of participants 115.

Further, the temporal driving skill model generator 108 and the iterative grouping component 110 provide inputs to a trip planning and scheduling recommendation component 112, which also receives the forecast data 106 as input. Component 112, based on these inputs, can then generate a detailed trip plan, for example, with driver assignments for different segments of the trip.

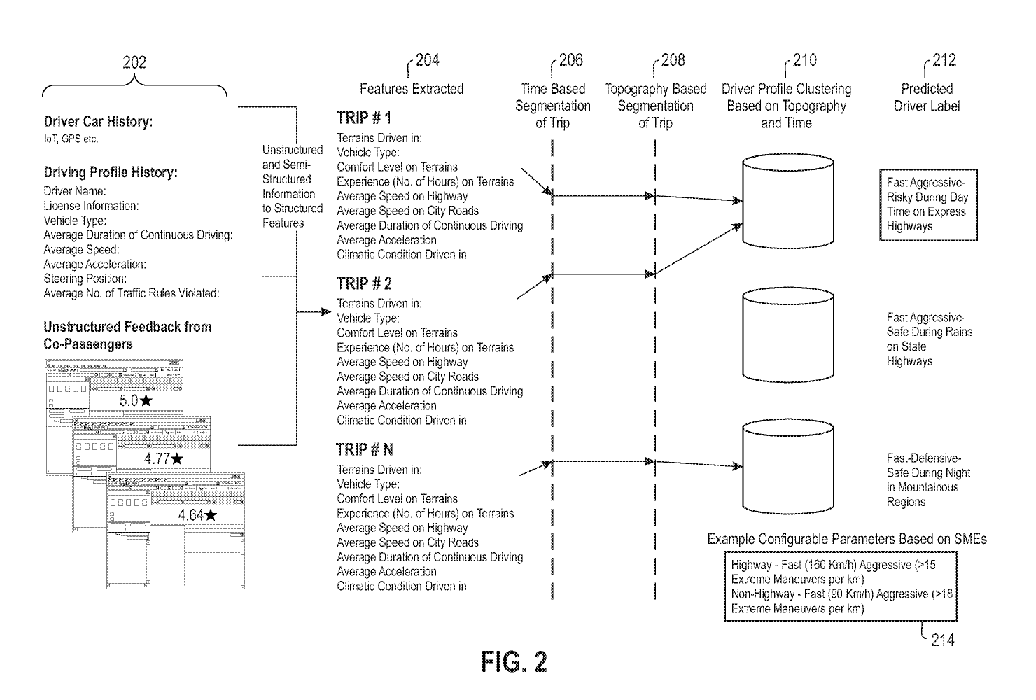

FIG. 2 is a diagram illustrating segmentation of drivers, according to an exemplary embodiment of the invention. As detailed above and further herein, at least one embodiment of the invention includes clustering drivers into groups based on driving data, topography and environmental factors. By way of illustration, FIG. 2 depicts inputs 202 including driver and vehicle history data, driver profiles (with data pertaining to speed, acceleration, steering position, etc.), and unstructured feedback from passengers. The unstructured and semi-structured information derived from inputs 202 can then be utilized to generate structured features 204, which can be broken down by trip. Each such trip can then be segmented based on time (as shown via component 206) and on topography (as shown via component 208).

The trips (for each driver) can then be clustered into groups 210 for given topographies and time parameters using features 204 such as trip speed quantiles, acceleration quantiles, steering position, user ratings, features extracted from reviews, etc. Additionally, one or more embodiments of the invention can include determining a label 212 to be applied to each driver for the different topographies and time parameters. Such label can be generated, for example, based on the clusters containing the largest number of trips. Additionally, such labels can include, for example, fast-aggressive-risky during the day on highways, fast-aggressive-safe during periods of rain on highways, fast-defensive-safe during the night on mountainous roads, etc. In distinguishing between various driver qualifiers (such as “risky” driving versus “safe” driving, “aggressive” driving versus “defensive” driving, etc.), at least one embodiment of the invention can implement configurable parameters 214. Such configurable parameters 214 can include setting a threshold speed value denoting a designation of “fast,” as well as a threshold number of extreme maneuvers (per a given distance) denoting a designation of “aggressive.”

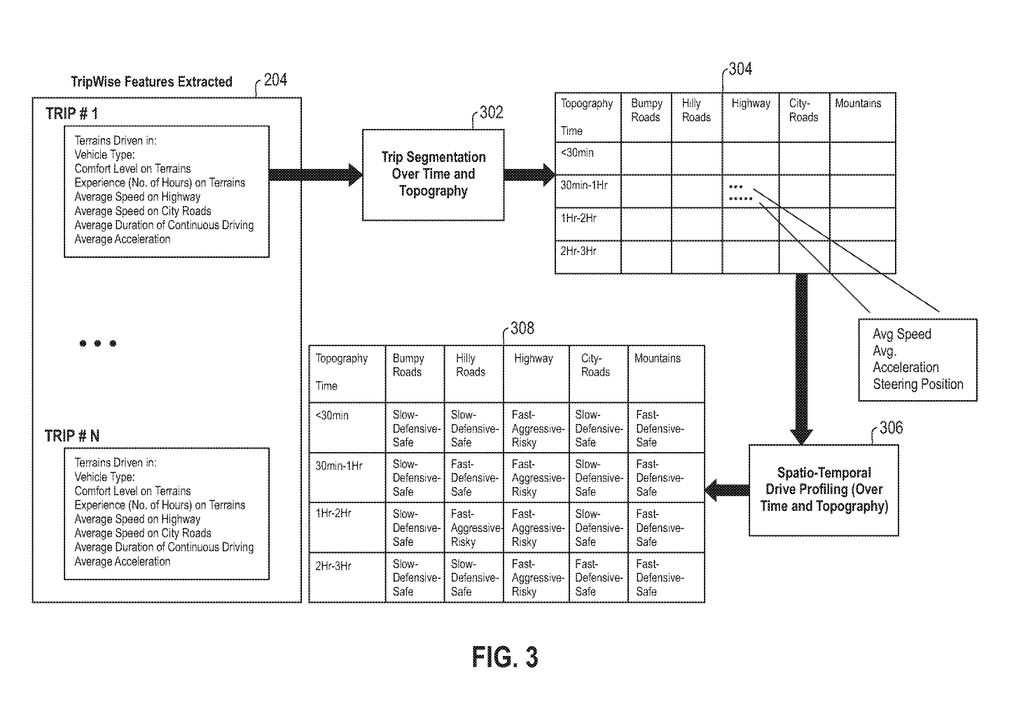

FIG. 3 is a diagram illustrating temporal driving skill model generation, according to an exemplary embodiment of the invention. As detailed above and further herein, at least one embodiment of the invention includes generating a temporal driving skill model for a given driver with respect to topography and/or one or more environmental factors. By way of illustration, FIG. 3 depicts extracted features 204 (such as detailed above), which are utilized to segment all trips of a given driver 302 based on time parameters and topographies (similar to components 206 and 208 in FIG. 2, as described above).

Also, in furtherance of the segmentation process 302, table 304 can be generated (and ultimately populated). For example, for each type of given topography, and across all trips for a particular driver, table 304 can breakdown the trips into different parts based on the elapsed time (for example, (i) less than 30 minutes (min), (ii) 30 min-1 hour (hr), (iii) 1 hr-2 hr, and (iv) 2 hr-3 hr). Further, for each part, profiling component 306 can construct a feature profile (using speed, acceleration, steering position, etc.) and map the profile to an associated cluster (such as depicted via component 210 in FIG. 2), thereby generating table 308. Additionally, for a given driver, at least one embodiment of the invention can include denoting if there is change in mapped cluster for different parts of a trip. For example, for an initial part of a trip, the driver may be classified as “Slow-Defensive-Safe,” but then the driver may subsequently be classified as “Fast-Defensive-Safe,” and after 1 hour, the driver may be classified as “Fast-Aggressive-Risky.”

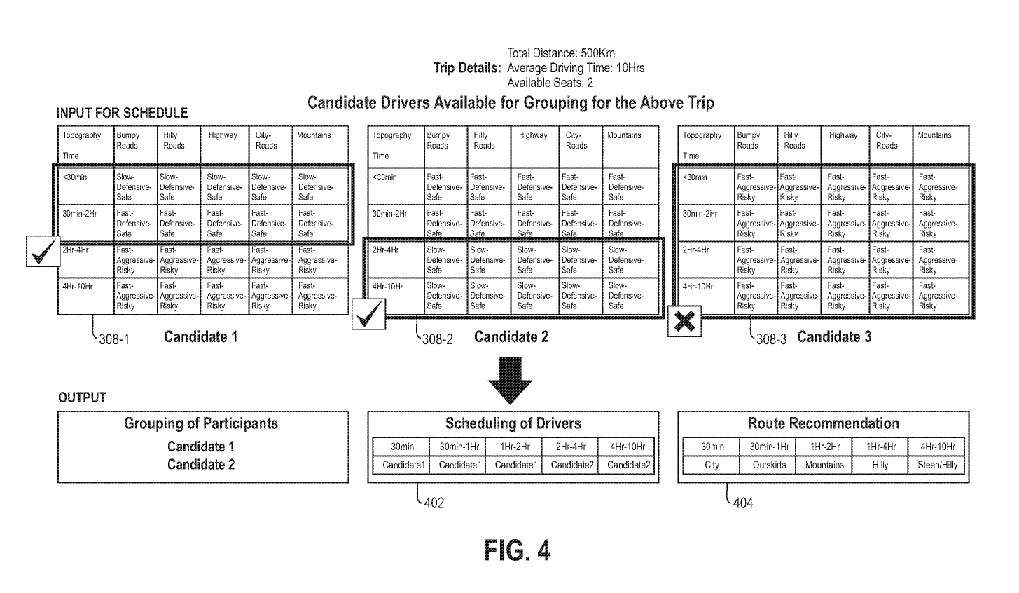

FIG. 4 is a diagram illustrating joint recommendations of route and grouping of participants, according to an exemplary embodiment of the invention. By way of illustration, FIG. 4 depicts inputs that include driver data tables 308-1, 308-2 and 308-3 corresponding candidate driver 1, candidate driver 2 and candidate driver 3, respectively, related to the give trip. Also, additional inputs can include one or more constraints, as well as trip details such as total distance of the trip, average driving time for the trip, available seats in the vehicle, etc. Such constraints can include constraints based on user preference(s), inability to drive, particular route(s), etc. Based on such inputs, at least one embodiment of the invention can include generating an output that includes a schedule 402 that includes assignments of drivers/users to each of one or more blocks of time for the trip, as well as a recommended optimal route 404 for the trip.

Such an embodiment can include, for each vehicle, finding a feasible set of driver allocation/assignment that satisfies all noted constraints. Additionally, for each vehicle, such an embodiment can also include examining all potential routes for the trip, and selecting one route in conjunction with one feasible set of driver allocation based on the topography of the trip, such that user safety constraints are satisfied. For all vehicles with no feasible allocation, at least one embodiment of the invention can include selecting an alternate route and repeating the above-noted steps.

Also, one or more embodiments of the invention can include, for each group of participants, identifying all participant constraints (slow driving in mountainous section, fast-defensive driving in general, etc.), and dividing the trip route into different segments based on the topography and time. For each segment, such an embodiment can include selecting one or more participants to drive based on their topography-based skills and temporal driving skills. Accordingly, such an embodiment can include generating an overall driver assignment schedule for each trip.

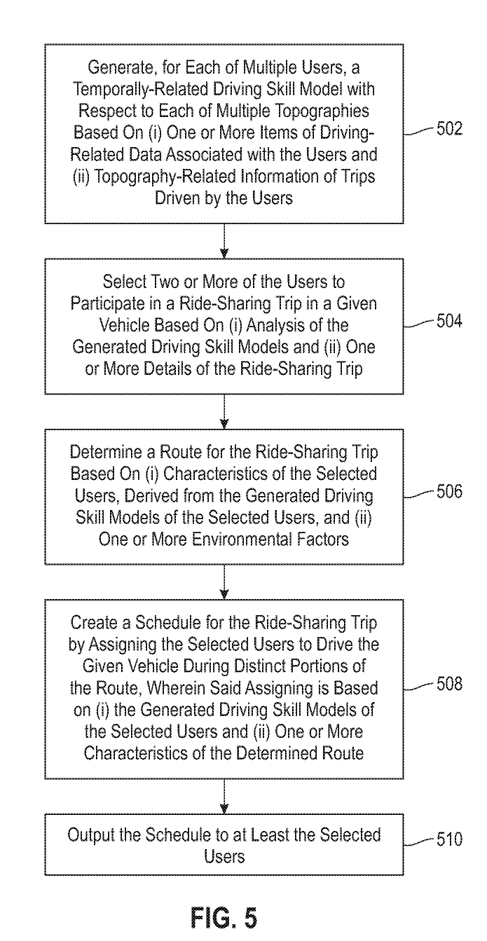

FIG. 5 is a flow diagram illustrating techniques according to an embodiment of the present invention. Step 502 includes generating, for each of multiple users, a temporally-related driving skill model with respect to each of multiple topographies based on (i) one or more items of driving-related data associated with the users and (ii) topography-related information of trips driven by the users. Additionally, the temporally-related driving skill model can be further based on one or more environmental factors attributed to trips driven by the users. Also, the items of driving-related data can include global positioning system data pertaining to trips driven by the users, Internet of things data pertaining to trips driven by the users, and passenger review information pertaining to trips driven by the users.

Additionally, generating the driving skill models can include segmenting each trip into multiple segments based on elapsed time. Further, at least one embodiment of the invention can include analyzing one or more changes in driving skill across the multiple segments.

Step 504 includes selecting two or more of the users to participate in a ride-sharing trip in a given vehicle based on (i) analysis of the generated driving skill models and (ii) one or more details of the ride-sharing trip. Also, selecting the users can be further based on one or more user constraints associated with one or more of the multiple users.

Step 506 includes determining a route for the ride-sharing trip based on (i) characteristics of the selected users, derived from the generated driving skill models of the selected users, and (ii) one or more environmental factors. The environmental factors can include one or more topographies associated with multiple plausible routes.

Step 508 includes creating a schedule for the ride-sharing trip by assigning the selected users to drive the given vehicle during distinct portions of the route, wherein said assigning is based on (i) the generated driving skill models of the selected users and (ii) one or more characteristics of the determined route. Also, assigning can be further based on a forecast of one or more weather conditions, and/or one or more user constraints associated with the selected users. Additionally, the characteristics of the determined route can include one or more topographies of the determined route, the distance of the determined route, and an expected travel time associated with the determined route.

Step 510 includes outputting the schedule to at least the selected users.

Also, an additional embodiment of the invention includes generating, for each of multiple users, a model that classifies a user's driving skill with respect to (i) each of multiple topographies and (ii) multiple durations of elapsed driving time, wherein generating comprises analyzing (a) one or more items of driving-related data associated with the users and (b) topography-related information of trips driven by the users. Such an embodiment can also include selecting two or more of the users to participate in a ride-sharing trip in a given vehicle based on (i) analysis of the generated models and (ii) one or more details of the ride-sharing trip. Further, such an embodiment can additionally include determining a route for the ride-sharing trip based on (i) characteristics of the selected users, derived from the generated models of the selected users, and (ii) one or more environmental factors, and segmenting the ride-sharing trip in multiple segments based on (i) elapsed travel time, (ii) topography-related information of the ride-sharing trip, and (iii) one or more of the environmental factors. Also, such an embodiment can include creating a schedule for the ride-sharing trip by assigning one of the selected users to drive the given vehicle during each of the multiple segments, wherein assigning is based on (i) the generated models of the selected users and (ii) one or more characteristics of the determined route, and outputting the schedule to at least the selected users.

At least one embodiment of the invention (such as the techniques depicted in FIG. 5, for example), can include implementing a service via a transmission server to receive data from a data source and send selected data to users (for example, at a provided destination address of a wireless device (such as a number for a cellular phone, etc.)). The transmission server includes a memory, a transmitter, and a microprocessor. Such an embodiment of the invention can also include providing a viewer application to the users for installation on their individual devices. Additionally, in such an embodiment of the invention, after a user enrolls, the service receives driver skill and trip information sent from a data source to the transmission server. The server can process the information, for example, based upon user-provided user preference information that is stored in memory on the server. Subsequently, an alert is generated containing the recommended trip route and driver schedule. The alert can be formatted into data blocks, for example, based upon any provided alert format preference information. Subsequently, the alert and/or formatted data blocks are transmitted over a data channel to the user's wireless device. After receiving the alert, the user can connect the wireless device to the user's computer, whereby the alert causes the user's computer to automatically launch the application provided by the service to display the alert. When connected to the Internet, the user may then use the viewer application (for example, via clicking on a URL associated with the data source provided in the alert) to facilitate a connection from the remote user computer to the data source over the Internet for additional information.

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

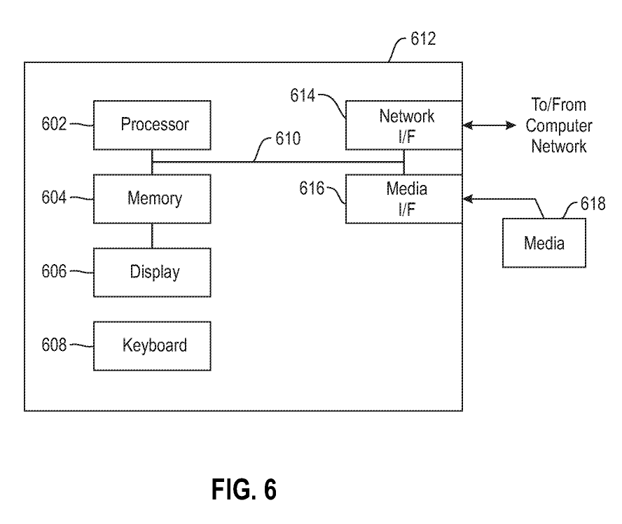

Additionally, an embodiment of the present invention can make use of software running on a computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

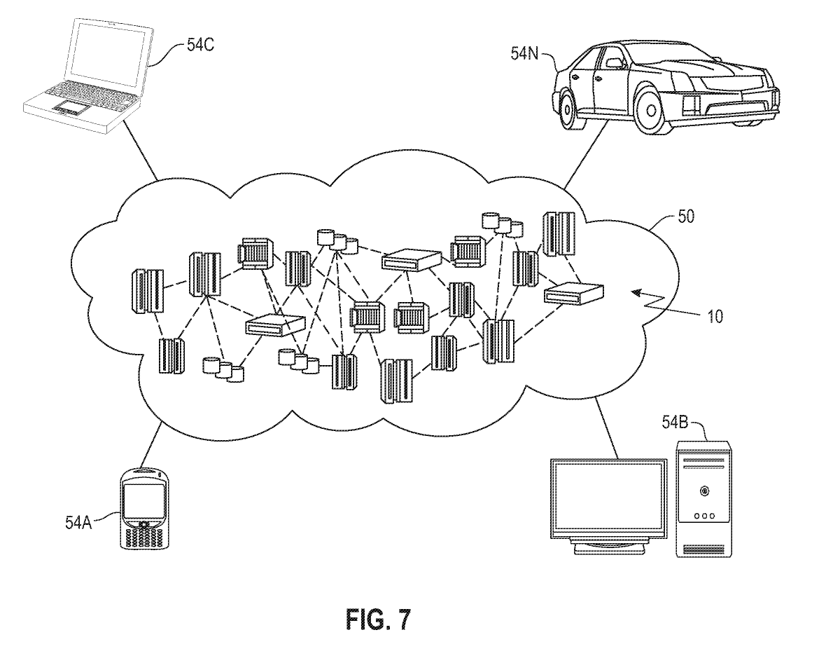

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

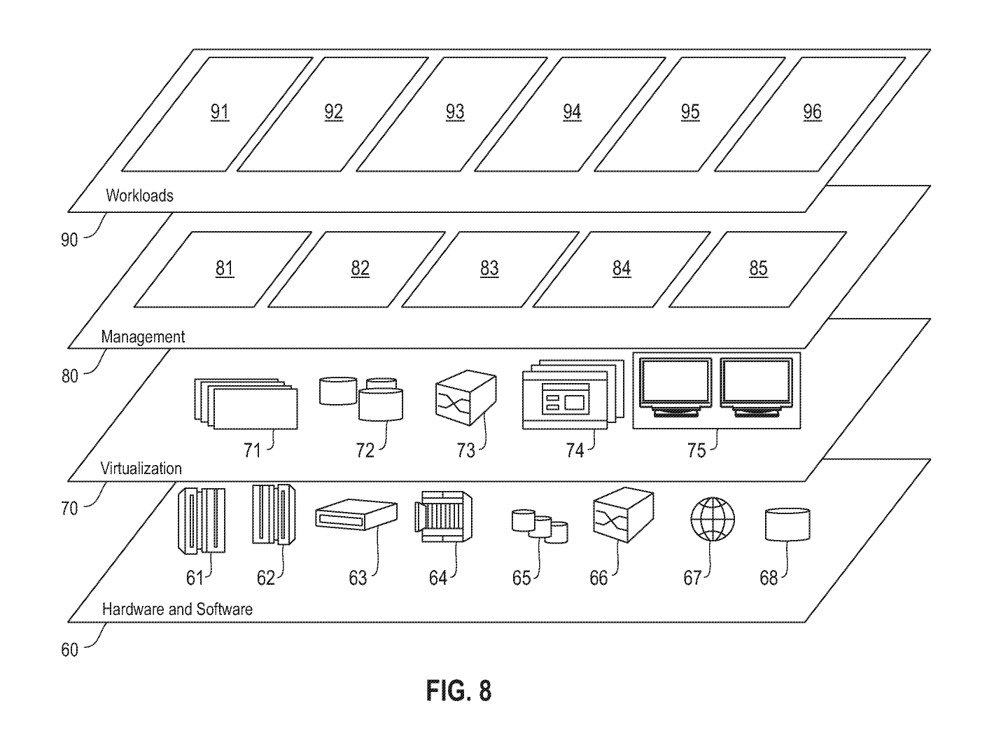

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and trip planning and scheduling recommending 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, scheduling a trip route based on temporal driving skills of the driver(s) and allocating each driver to a specific route area by segmenting the route into multiple areas.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating, for each of multiple users, a temporally-related driving skill model pertaining to each of multiple topographies, wherein the temporally-related driving skill model is based on (i) one or more items of driving-related data associated with the users and (ii) topography-related information of trips driven by the users;
selecting two or more of the users to participate in a ride-sharing trip in a given vehicle based on (i) analysis of the generated driving skill models and (ii) one or more details of the ride-sharing trip;
determining a route for the ride-sharing trip based on (i) characteristics of the selected users, derived from the generated driving skill models of the selected users, and (ii) one or more environmental factors;
creating a schedule for the ride-sharing trip by assigning the selected users to drive the given vehicle during distinct portions of the route, wherein said assigning is based on (i) the generated driving skill models of the selected users and (ii) one or more characteristics of the determined route; and
outputting the schedule to at least the selected users;
wherein the steps are carried out by at least one computing device.

2. The computer-implemented method of claim 1, wherein said temporally-related driving skill model is based on one or more environmental factors attributed to trips driven by the users.

3. The computer-implemented method of claim 1, wherein the one or more items of driving-related data comprise global positioning system data pertaining to trips driven by the users.

4. The computer-implemented method of claim 1, wherein the one or more items of driving-related data comprise Internet of things data pertaining to trips driven by the users.

5. The computer-implemented method of claim 1, wherein the one or more items of driving-related data comprise passenger review information pertaining to trips driven by the users.

6. The computer-implemented method of claim 1, wherein said generating comprises segmenting each trip into multiple segments based on elapsed time.

7. The computer-implemented method of claim 6, comprising:
analyzing one or more changes in driving skill across the multiple segments.

8. The computer-implemented method of claim 1, wherein said selecting is based on one or more user constraints associated with one or more of the multiple users.

9. The computer-implemented method of claim 1, wherein the one or more environmental factors comprises one or more topographies associated with multiple plausible routes.

10. The computer-implemented method of claim 1, wherein said assigning is further based on a forecast of one or more weather conditions.

11. The computer-implemented method of claim 1, wherein said assigning is based on one or more user constraints associated with the selected users.

12. The computer-implemented method of claim 1, wherein the one or more characteristics of the determined route comprises one or more topographies of the determined route.

13. The computer-implemented method of claim 1, wherein the one or more characteristics of the determined route comprises the distance of the determined route.

14. The computer-implemented method of claim 1, wherein the one or more characteristics of the determined route comprises an expected travel time associated with the determined route.

15. A computer program product comprising a computer readable storage medium having program instructions embodied therewith, the program instructions executable by a device to cause the device to:
generate, for each of multiple users, a temporally-related driving skill model pertaining to each of multiple topographies, wherein the temporally-related driving skill model is based on (i) one or more items of driving-related data associated with the users and (ii) topography-related information of trips driven by the users;
select two or more of the users to participate in a ride-sharing trip in a given vehicle based on (i) analysis of the generated driving skill models and (ii) one or more details of the ride-sharing trip;
determine a route for the ride-sharing trip based on (i) characteristics of the selected users, derived from the generated driving skill models of the selected users, and (ii) one or more environmental factors;
create a schedule for the ride-sharing trip by assigning the selected users to drive the given vehicle during distinct portions of the route, wherein said assigning is based on (i) the generated driving skill models of the selected users and (ii) one or more characteristics of the determined route; and
output the schedule to at least the selected users.

16. The computer program product of claim 15, wherein said temporally-related driving skill model is further based on one or more environmental factors attributed to trips driven by the users.

17. The computer program product of claim 15, wherein said generating comprises segmenting each trip into multiple segments based on elapsed time.

18. The computer program product of claim 17, wherein the program instructions executable by a device to cause the device to:
analyze one or more changes in driving skill across the multiple segments.

19. A system comprising:
a memory; and
at least one processor coupled to the memory and configured for:
generating, for each of multiple users, a temporally-related driving skill model pertaining to each of multiple topographies, wherein the temporally-related driving skill model is based on (i) one or more items of driving-related data associated with the users and (ii) topography-related information of trips driven by the users;
selecting two or more of the users to participate in a ride-sharing trip in a given vehicle based on (i) analysis of the generated driving skill models and (ii) one or more details of the ride-sharing trip;
determining a route for the ride-sharing trip based on (i) characteristics of the selected users, derived from the generated driving skill models of the selected users, and (ii) one or more environmental factors;
creating a schedule for the ride-sharing trip by assigning the selected users to drive the given vehicle during distinct portions of the route, wherein said assigning is based on (i) the generated driving skill models of the selected users and (ii) one or more characteristics of the determined route; and
outputting the schedule to at least the selected users.

20. A computer-implemented method, comprising:
generating, for each of multiple users, a model that classifies a user's driving skill with respect to (i) each of multiple topographies and (ii) multiple durations of elapsed driving time, wherein said generating comprises analyzing (a) one or more items of driving-related data associated with the users and (b) topography-related information of trips driven by the users;
selecting two or more of the users to participate in a ride-sharing trip in a given vehicle based on (i) analysis of the generated models and (ii) one or more details of the ride-sharing trip;
determining a route for the ride-sharing trip based on (i) characteristics of the selected users, derived from the generated models of the selected users, and (ii) one or more environmental factors;
segmenting the ride-sharing trip in multiple segments based on (i) elapsed travel time, (ii) topography-related information of the ride-sharing trip, and (iii) one or more of the environmental factors;
creating a schedule for the ride-sharing trip by assigning one of the selected users to drive the given vehicle during each of the multiple segments, wherein said assigning is based on (i) the generated models of the selected users and (ii) one or more characteristics of the determined route; and
outputting the schedule to at least the selected users;
wherein the steps are carried out by at least one computing device.
